(19) United States
(12) Patent Application Publication
(10) Pub. No.: US 2015/0211348 A1
(43) Pub. Date: Jul. 30, 2015

(54) H2S Removal Using Scavenging Material for Gravel Pack

(71) Applicants: John J. Lawrence, Houston, TX (US); Jennifer A. Hornemann, Englewood, CO (US); Bruce A. Dale, Sugar Land, TX (US)

(72) Inventors: John J. Lawrence, Houston, TX (US); Jennifer A. Hornemann, Englewood, CO (US); Bruce A. Dale, Sugar Land, TX (US)

(21) Appl. No.: 14/415,693

(22) PCT Filed: Jul. 12, 2013
(86) PCT No.: PCT/US2013/050375

§ 371 Date: Jan. 19, 2015

Related U.S. Application Data
(60) Provisional application No. 61/703,128, filed on Sep. 19, 2012.

(51) Int. Cl. E21B 43/38; E21B 43/16; E21B 43/04; C02F 1/70; C02F 3/34

(52) U.S. Cl. CPC E21B 43/38; C02F 1/705; C02F 3/34; E21B 43/04; E21B 43/16; C02F 2101/101

(57) ABSTRACT

A method of producing hydrocarbons through a production well connected to a subterranean hydrocarbon reservoir includes completing the production well in fluid communication with the subterranean hydrocarbon reservoir and placing a gravel pack in the production well. The gravel pack comprises hydrogen sulfide, H₂S, scavenging material such as siderite, iron oxides such as magnetite, or other suitable H₂S scavenging material.

### CROSS-REFERENCE TO RELATED APPLICATIONS

This application claims priority to U.S. provisional patent application No. 61/703,128 filed on Sep. 19, 2012 entitled “H₂S Removal Using Scavenging Material for Gravel Pack,” the entirety of which is incorporated by reference herein.

### FIELD OF THE DISCLOSURE

Embodiments of the present disclosure are directed toward the removal of hydrogen sulfide, H₂S, from produced reservoir fluids, and more specifically, toward the removal of H₂S from produced reservoir fluids entering a gravel pack portion of a well.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Within approximately the last 40 years, the injection of seawater or any water containing sulfates and other nutrients, for waterflooding petroleum reservoirs has been determined, and is now well known, to cause reservoir souring. The primary mechanism for reservoir souring is the conversion of sulfate or sulfite to hydrogen sulfide (H₂S) via sulfate reducing micro-organisms. An example reaction for this process is when sulfate reducing bacteria (SRB) or sulfate reducing archaea (SRA) consume volatile fatty acids is:

CH₃COOH+SO₄²⁻+2H⁺→H₂S+2H₂O+2CO₂

This process can occur in any reservoir where the reservoir temperature is within the range for sulfate reducing microorganism activity and sufficient nutrients are available. This souring process can also occur in warmer reservoirs where injected water creates a cooled zone in the vicinity of the injector resulting in a region of biological activity.

Generation and transport of the H₂S occurs primarily in the water phase during reservoir souring. The level of H₂S in the reservoir water phase can range from a few mg/l to just above 100 mg/l. The level of souring is dependent on the temperature and typical reservoir souring levels will rise to about 50 mg/l in produced seawater. When this level of H₂S is combined with high watercut and flashed with produced hydrocarbon production of oil and gas, much higher levels of H₂S can be reached in the process streams, particularly the gas phase, due to the tendency for the H₂S to come out of solution at low pressure. A recent study for Equatorial Guinea found H₂S concentrations in the vapor could reach 500 to 1000 ppm with H₂S concentrations in the produced water of only 50 mg/l.

This level of H₂S can cause significant corrosion problems and significant increased costs in materials used downhole and on the surface. Additional costs are incurred in safety system requirements to handle the presence of the H₂S. Estimates of additional material costs to accommodate sour production can total $500,000,000 USD, with the incremental costs split about evenly between subsurface and surface materials.

Methods have been developed in recent years to mitigate reservoir souring, but all have shortcomings Treatment of injected water with biocide can be effective at killing planktonic micro-organisms, but is usually ineffective at killing micro-organisms attached to reservoir surfaces and encased in a protective biofilm. Because of this and other factors, biocides are often ineffective at preventing reservoir souring. Sulfate removal can be effective at preventing reservoir souring, but is costly and adds significantly to weight of offshore installations. Equipment downtime can also be problematic. Nitrate injection is being performed in some fields. This process stimulates the growth of nitrate reducing bacteria (NRB) so that SRB and SRA do not produce H₂S. This process requires the presence of the appropriate bacteria and will increase the bacteria population in the reservoir.

In the event that nitrate injection is ceased, many of the NRB can also reduce sulfate and amplify the souring problem. NRB can also result in complications for surface corrosion.

The need exists for new approaches to improve the performance of reservoir souring mitigation processes. In addition, the need exists to lower the costs of materials used downhole and at the surface that are required because of the presence of sour hydrocarbons.

### SUMMARY

One or more embodiments of the present disclosure provide a method for reducing the hydrogen sulfide content of produced fluids from a hydrocarbon reservoir. An embodiment of the disclosure places hydrogen sulfide (H₂S) scavenging materials in the flowpath of produced, sour, hydrocarbon fluids by using the scavenging material as a gravel pack substance. Further, inflow control devices (ICDs) may be used to control the flow of the produced fluid so that the produced fluid will be forced to have sufficient resident time with the scavenging material to ensure that H₂S is adequately removed. This use of gravel packs utilizing H₂S scavenging materials may be made even when sand influx is not a problem in the reservoir. Once the scavenging material is spent or no longer effective, if necessary, a workover could be performed to replace the gravel pack with fresh scavenging material. An existing production well which is experiencing the production of sour fluids may have a H₂S scavenging gravel pack installed in the well through a workover. Non-limiting examples of H₂S scavenging materials include siderite (FeCO₃), iron oxides including magnetite (Fe₃O₄) and Fe₂O₃, or other H₂S scavenging materials.

### BRIEF DESCRIPTION OF THE DRAWINGS

The foregoing and other advantages of the present techniques may become apparent upon reviewing the following detailed description and drawings of non-limiting examples of embodiments in which:

FIGS. 1A-C are side views of exemplary illustrations of types of gravel packs according to an embodiment of the preset invention;

FIG. 2 is a graph of water and H₂S production for a well in Equatorial New Guinea;

FIG. 3 is a graph of estimated scavenging of H₂S for the well of FIG. 3 using a H₂S scavenging gravel pack comprising magnetite in accordance with certain embodiments of the present invention; and

FIG. 4 is a graph of estimated scavenging of H₂S for the well of FIG. 3 using a H₂S scavenging gravel pack comprising magnetite and also nitrate injection in accordance with certain embodiments of the present invention.

### DETAILED DESCRIPTION

In the following detailed description section, the specific embodiments of the present techniques are described in connection with preferred embodiments. However, to the extent that the following description is specific to a particular embodiment or a particular use of the present techniques, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Gravel packs as a well completion technique have been used in the industry for control of sand entering the well. However, gravel packs are a relatively expensive method of completing a well and have additional drawbacks including increased drawdown which may decrease well productivity, reduction of the operating wellbore diameter which may necessitate the need for artificial lift equipment to be set above the zone, and the potential for the carrier fluid that helps place the gravel pack to damage the reservoir permeability and further restrict production. For these reasons, the use of gravel packs requires careful study and evaluation to determine whether the benefits are greater than the risks incurred through their use. Their use has been limited to applications requiring stopping sand movement.

An embodiment of the disclosure places hydrogen sulfide (H₂S) scavenging materials in the flowpath of produced, sour, hydrocarbon fluids by using the scavenging material as a gravel pack substance. Further, inflow control devices (ICDs) may be used to control the flow of the produced fluid so that the produced fluid will be forced to have sufficient resident time with the scavenging material to ensure that H₂S is adequately removed. Alternatively, a decision could be made to accept less thorough H₂S scavenging in favor of higher production rates. Gravel packs utilizing H₂S scavenging materials may be used even when sand control is not a problem in the reservoir. Once the scavenging material is spent or no longer effective, if necessary, a workover could be performed to replace the gravel pack with fresh scavenging material. An existing production well which is experiencing the production of sour fluids may have a H₂S scavenging gravel pack installed in the well through a workover. Non-limiting examples of H₂S scavenging materials include siderite (FeCO₃), iron oxides including magnetite (Fe₃O₄) and Fe₂O₃, or other H₂S scavenging materials.

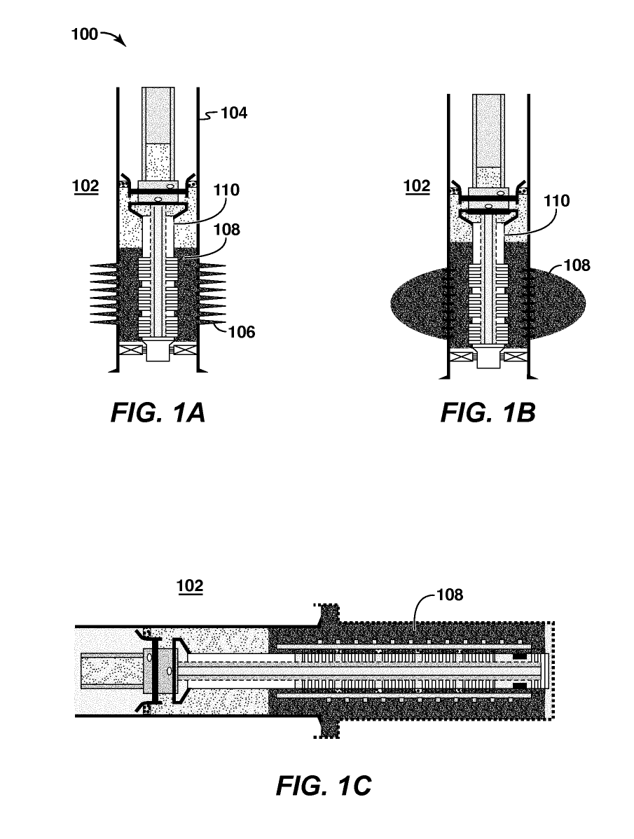

Referring to FIG. 1a, illustrated is an embodiment of the disclosure in which an oil and gas well 100 is completed in a formation 102. As is well known to one of ordinary skill in the art, the oil and gas well 100 includes a casing 104 and perforations 106. A H₂S scavenging material 108 is used as a gravel pack material within the annulus between the casing 104 and the production tubing 110.

In the embodiment shown in Figure lb, the H₂S scavenging material 108 is included as part of the hydraulic fracturing of the formation 102 and results in the H₂S scavenging material being distributed outside of the casing 104 and within the formation 102, in addition to the H₂S scavenging material 108 being within the annulus between the casing 104 and the production tubing 110. In another embodiment of the invention illustrated in FIG. 1c, the H₂S scavenging material 108 is used as a gravel pack in an open hole, horizontal well, without a casing. Other completion configurations using H₂S scavenging gravel packs are within the scope of this disclosure and this disclosure is not limited to the type of gravel pack completion.

Test calculations were performed to examine the feasibility of an embodiment of the disclosure from a material balance standpoint. The basis for the test calculations come from a well in Equatorial Guinea. The well has an approximate 2275 ft. gravel pack with a 7 inch screen. The assumed open hole diameter is 8.5 inches resulting in a total volume of about 288.5 ft³.

Magnetite has a few advantages over siderite as a H₂S scavenging material, including better stoichiometry and greater density. Magnetite was assumed to have a bulk gravel pack density of 160 lb/ft³ (2.56 g/cc or 72.6 kg/ft³) which is about ½ the density of pure magnetite (322 lb/ft³). This resulted in total mass of magnetite of 46,160 lbs or 20,937 kg. Note that because flow through the scavenger material between the screen and the packer is limited, that scavenger material is assumed to be inaccessible and is not included in the mass.

The stoichiometry of the scavenging reaction with magnetite is:

Fe₃O₄+6H₂S→3FeS₂+4H₂O+2H₂

Note that the reaction products can vary depending on the presence of other compounds. Thus, 1 kg of Fe₃O₄ has the capacity to scavenge 0.883 kg of H₂S. By comparison, the stoichiometry of the scavenging reaction with siderite is:

FeCO₃+2H₂S→FeS₂+H₂CO₃+H₂

1 kg of FeCO₃ has the capacity to scavenge 0.588 kg of H₂S.

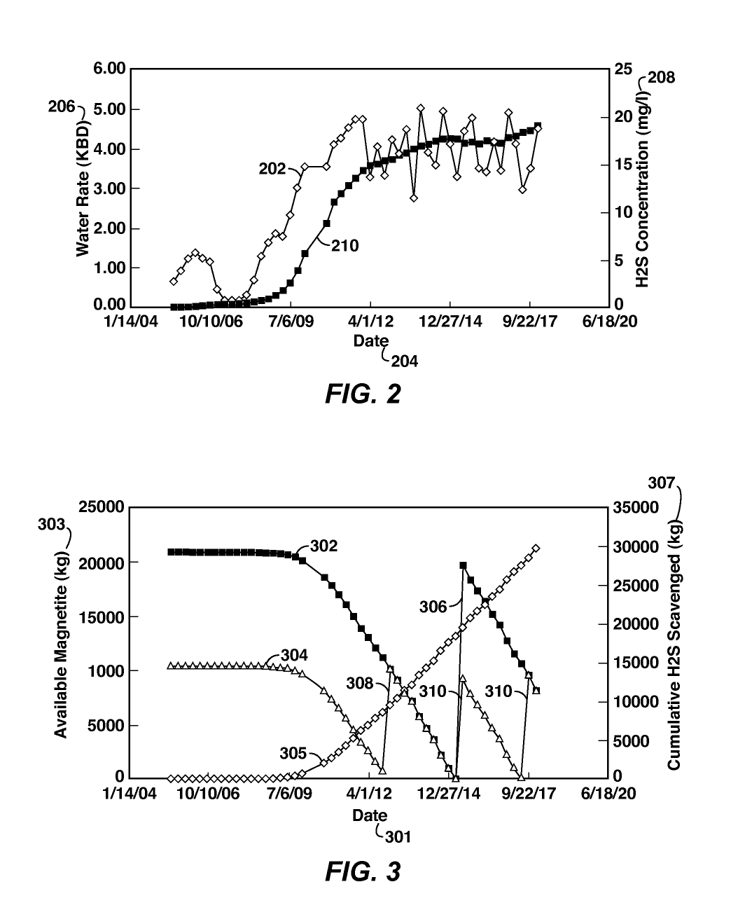

Referring to FIG. 2, reservoir simulation was used to generate a water production profile 202 for the abovementioned well in Equatorial Guinea. The date 204 is indicated on the bottom axis, the water rate 206 in thousands of barrels per day (kBD) is indicated on the left, vertical axis. The H₂S concentration 208 in milligrams per liter (mg/l) is indicated on the right, vertical axis. Seawater tracers in the simulation along with the assumption of 50 mg/l H₂S in the produced seawater were used to generate an overall H₂S production profile 210. This profile was in turn used to assess how long the magnetite in the gravel pack could provide H₂S scavenging.

FIG. 3 shows a material balance on the magnetite for two different assumptions. The date 301 is indicated on the bottom axis, the available magnetite 303 in kilograms is indicated on the left, vertical axis. The cumulative H₂S scavenged 307 in kilograms is indicated on the right, vertical axis. The magnetite usage curve 302 indicates how long the magnetite could scavenge H₂S assuming that 100% of the magnetite could be accessed and react with the H₂S. The magnetite usage curve 304 indicates how long the magnetite could scavenge H₂S assuming that only 50% of the magnetite could be accessed and react with the H₂S. In either instance, H₂S curve 305 provides the total H₂S scavenged. The 100% effectiveness case, magnetite usage curve 302, resulted in H₂S scavenging for about 10 years at which time a workover 306 was assumed to replace the gravel pack with fresh magnetite. The fresh magnetite from that workover provided sufficient scavenging for the remainder of the well life. The 50% effectiveness case, magnetite usage curve 304, resulted in the initial gravel pack providing H₂S scavenging for about 7 years at which time a workover 308 was assumed to replace the gravel pack with fresh siderite. The fresh magnetite from the workover 308 provided sufficient scavenging material for a little over two years resulting in the need for subsequent workovers 310.

The means for performing workovers to replenish the source of scavenger material are varied and dependent on the amount of scavenger required for the remaining life of the well, the configuration of the original completion, the overall condition of the well, and the workover systems and/or methods available for well access. For example, in the event of an initial completion consisting of a cased-hole gravel pack or frac pack, such as in FIGS. 2a and 2b, it is fairly easy and routine to recover sand screens, circulate out the original gravel material, re-perforate the interval and re-gravel pack the well. However, in an openhole completion, which frequently are employed in long-horizontal wells, it may be very difficult and usually cost-prohibitive to recover sand screens, and thus, normally a whipstock and/or plug is set to isolate the original completion and side-track drilling is performed to re-drill the reservoir intervals and install a new open-hole gravel pack.

Alternatively, in either cased-hole or open-hole completions, an inner gravel pack or an inner pre-packed sand screen may be run within the original completion. In this scenario, the original gravel pack is not recovered and higher pressure losses generally are encountered during production due the inclusion of the small diameter sand screens, however this may be compatible with late life well performance expectations. In addition, it may be possible to run the inner sand screens through the production tubing (e.g., via coiled tubing or small diameter workstring), thereby eliminating the need for a large completion or drilling rig to first pull the production tubing. Pre-packed sand screens may be of conventional designs or may include new “self-healing” designs developed by ExxonMobil (e.g., MazeFlo) in which case higher drawdown may be permissible if higher production rates are desired.

The disclosure may also have significant utility in combination with other reservoir souring mitigation methods, such as nitrate injection, where that method is not completely effective. For example, if nitrate injection was performed with the injection well associated with the abovementioned well in Equatorial Guinea and that nitrate injection resulted in 80% effectiveness in the prevention of reservoir souring, significant H₂S would still remain and result in a need for special alloys in the production tubulars and facilities. In this scenario, H₂S scavenging gravel packs could be used to remove the remaining H₂S over the complete life of the well with either of the 100% or 50% scavenging effectiveness assumptions as shown in FIG. 5.

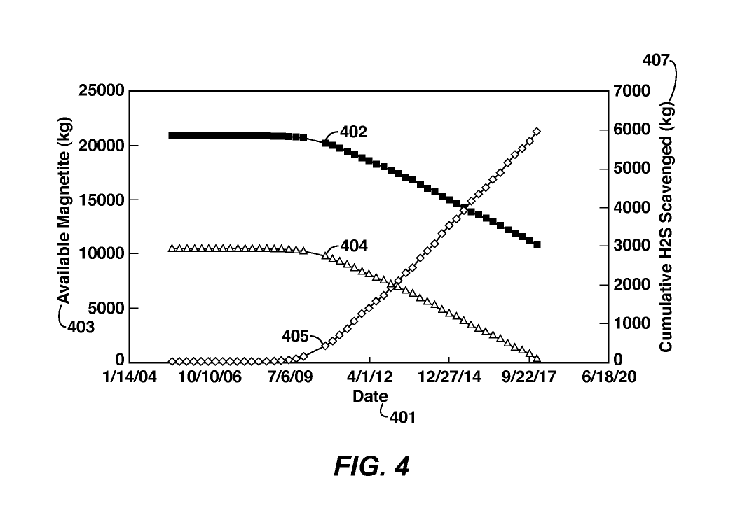

FIG. 4 shows a material balance on the magnetite when combined with nitrate injection for two different assumptions. The date 401 is indicated on the bottom axis, the available iron oxide 403 in kilograms is indicated on the left, vertical axis. The cumulative H₂S scavenged 407 in kilograms is indicated on the right, vertical axis. Similar to FIG. 3, the magnetite usage curve 402 indicates how long the magnetite could scavenge H₂S assuming that 100% of the magnetite could be accessed and react with the H₂S. The magnetite usage curve 404 indicates how long the magnetite could scavenge H₂S assuming that only 50% of the magnetite could be accessed and react with the H₂S. In either instance, H₂S curve 405 provides the total H₂S scavenged. When combined with an 80% effective nitrate injection, after approximately twelve years, the 100% effectiveness case still has approximately ½ of the magnetite life remaining. The 50% effectiveness case, magnetite usage curve 404, resulted in the initial gravel pack providing H₂S scavenging for about twelve years, approximately five years longer than what was expected without the nitrate injection.

Other embodiments may include other scavenging materials such as siderite, Fe₂O₃ or other compounds or minerals. Some scavengers, such as iron oxides, have the potential for downhole regeneration without a full workover. Another embodiment would include combinations of scavenging materials. Combinations of materials might provide better packing or better contact area with the produced fluids.

The disclosure's impact would be to significantly reduce materials cost in both the subsurface and surface where reservoir souring is the primary cause of H₂S production. The disclosure appears to be capable of mitigating the production of H₂S over the life of wells where souring is not extreme or produced water volumes are not large. In cases where souring is more extreme or the produced water volume is large enough to consume the scavenging material, workovers may be required to periodically replace the scavenging material. If the scavenging material can be regenerated, replacement of the scavenging material may be avoided. In extreme cases of souring or very high water production, the scavenging material may be consumed very quickly in some wells, requiring additional mitigation. The extreme cases should be isolated to specific wells in a field and the disclosure can still have a significant impact on reducing material costs.

### Embodiments

Illustrative, non-exclusive examples of systems and methods according to the present disclosure are presented in the following enumerated paragraphs. Embodiments of the disclosure may include any combinations of the methods and systems shown in the following numbered paragraphs. This is not to be considered a complete listing of all possible embodiments, as any number of variations can be envisioned from the description above.

A1. A method of producing hydrocarbons through a production well connected to a subterranean hydrocarbon reservoir, the method comprising:
completing the production well in fluid communication with the subterranean hydrocarbon reservoir,
wherein the production well further comprises a gravel pack, and
wherein the gravel pack comprises H₂S scavenging material.

A2. The method of paragraph A1, wherein the H₂S scavenging material comprises FeCO₃.

A3. The method of preceding paragraphs A1-A2, wherein the H₂S scavenging material comprises Fe₃O₄.

A4. The method of preceding paragraphs A1-A3, wherein the H₂S scavenging material comprises Fe₂O₃.

A5. The method of preceding paragraphs A1-A4, wherein the H₂S scavenging material comprises a suitable H₂S scavenging material.

A6. The method of preceding paragraphs A1-A5, wherein the H₂S scavenging material comprises FeCO₃, Fe₃O₄, Fe₂O₃, a suitable H₂S scavenging material, or any combination of the above materials.

A7. The method of preceding paragraphs A1-A6, further comprising injecting the subterranean hydrocarbon reservoir with a nitrate reducing bacteria.

A8. A method of producing hydrocarbons through a production well connected to a subterranean hydrocarbon reservoir, the method comprising:

performing a workover on the production well in fluid communication with the subterranean hydrocarbon reservoir,
wherein the performing a workover further comprises installing a gravel pack, and
wherein the gravel pack comprises H₂S scavenging material.

A9. The method of preceding paragraph A8, wherein the H₂S scavenging material comprises FeCO₃.

A10. The method of preceding paragraphs A8-A9, wherein the H₂S scavenging material comprises Fe₃O₄.

A11. The method of preceding paragraphs A8-A10, wherein the H₂S scavenging material comprises Fe₂O₃.

A12. The method of preceding paragraphs A8-A11, wherein the H₂S scavenging material comprises a suitable H₂S scavenging material.

A13. The method of preceding paragraphs A8-A12, wherein the H₂S scavenging material comprises FeCO₃, Fe₃O₄, Fe₂O₃, a suitable H₂S scavenging material, or any combination of the above materials.

A14. The method of preceding paragraphs A8-A13, further comprising injecting the subterranean hydrocarbon reservoir with a nitrate reducing bacteria.

While the present techniques of the disclosure may be susceptible to various modifications and alternative forms, the exemplary embodiments discussed above have been shown by way of example. However, it should again be understood that the disclosure is not intended to be limited to the particular embodiments disclosed herein. Indeed, the present techniques of the disclosure are to cover all modifications, equivalents, and alternatives falling within the spirit and scope of the disclosure as defined by the following appended claims.

1. A method of producing hydrocarbons through a production well connected to a subterranean hydrocarbon reservoir, the method comprising:
completing the production well in fluid communication with the subterranean hydrocarbon reservoir,
wherein the production well further comprises a gravel pack, and
wherein the gravel pack comprises H₂ scavenging packing material consisting of H₂S scavenging material.

2. The method of claim 1, wherein the H₂S scavenging material comprises FeCO₃.

3. The method of claim 1, wherein the H₂S scavenging material comprises Fe₃O₄.

4. The method of claim 1, wherein the H₂S scavenging material comprises Fe₂O₃.

5. The method of claim 1, wherein the H₂S scavenging material comprises a suitable H₂S scavenging material.

6. The method of claim 1, wherein the H₂S scavenging material comprises FeCO₃, Fe₃O₄, Fe₂O₃, a suitable H₂S scavenging material, or any combination of the above materials.

7. The method of claim 1, further comprising injecting the subterranean hydrocarbon reservoir with a nitrate reducing bacteria.

8. A method of producing hydrocarbons through a production well connected to a subterranean hydrocarbon reservoir, the method comprising:
performing a workover on the production well in fluid communication with the subterranean hydrocarbon reservoir,
wherein the performing a workover further comprises installing a gravel pack, and
wherein the gravel pack comprises H₂S scavenging material consisting of H₂S scavenging material.

9. The method of claim 8, wherein the H₂S scavenging material comprises FeCO₃.

10. The method of claim 8, wherein the H₂S scavenging material comprises Fe₃O₄.

11. The method of claim 8, wherein the H₂S scavenging material comprises Fe₂O₃.

12. The method of claim 8, wherein the H₂S scavenging material comprises a suitable H₂S scavenging material.

13. The method of claim 8, wherein the H₂S scavenging material comprises FeCO₃, Fe₃O₄, Fe₂O₃, a suitable H₂S scavenging material, or any combination of the above materials.

14. The method of claim 8, further comprising injecting the subterranean hydrocarbon reservoir with a nitrate reducing bacteria.
